(19) United States
(12) Patent Application Publication
(10) Pub. No.: US 2015/0278031 A1
(43) Pub. Date: Oct. 1, 2015

(54) ADAPTIVE FILE BACKUP SYSTEM

(71) Applicant: QUALCOMM Incorporated, San Diego, CA (US)

(72) Inventors: Zachary David RATTNER, San Diego, CA (US); Robert Sean DALEY, Del Mar, CA (US); Flor de Maria LEVANDOSKI, Oceanside, CA (US)

(73) Assignee: QUALCOMM Incorporated, San Diego, CA (US)

(21) Appl. No.: 14/229,013

(22) Filed: Mar. 28, 2014

(51) Int. Cl. G06F 11/14

(52) U.S. Cl. CPC G06F 11/1464

(57) ABSTRACT

A resource availability score for a client device is determined based on metrics of one or more resources of the client device. Client device resources may include a central processing unit, memory, battery and a communications module. Metrics of the resources may include a percentage of CPU load, amount of available memory, remaining battery life, and communication signal quality. A backup urgency score for a file stored on the user device is determined based on metrics of one or more file parameters of the file. File parameters may include file size, file modification timestamp, timestamp of the last file access, file creation time stamp, timestamp of last file backup, and file creator. A determination of whether to back up the file to a storage device is made based on a comparison of the urgency score and the resource availability score.

### BACKGROUND

1. Field

The present disclosure relates generally to networks including client devices and backup devices, and more particularly, to a file backup utility that adaptively backs up files from client devices based on device resource availability and file parameters.

2. Background

Typical file backup utilities determine to backup files from a device based on criteria independent of the operation state of the device. For example, some utilities backup files at fixed intervals, for example, at the same time everyday. Other utilities may back up files as soon as a file is saved. Depending on how a user is using the device at the time of these backups, device operation and user experience may be adversely affected.

### SUMMARY

A resource availability score for a client device is determined based on metrics of one or more resources of the client device. Client device resources may include a central processing unit, memory, battery and a communications module. Metrics of the resources may include a percentage of CPU load, amount of available memory, remaining battery life, and communication signal quality. A backup urgency score for a file stored on the user device is determined based on metrics of one or more file parameters of the file. File parameters or metrics may include file size in bytes, file modification timestamp, timestamp of the last file access, file creation timestamp, timestamp of last file backup, and file creator. A determination of whether to back up the file to a storage device is made based on a comparison of the urgency score and the resource availability score.

The foregoing file backup utility presents a minimally-invasive user experience. The utility adapts to changing conditions and backs up files at a time when the user experience is not adversely affected. A file backup utility monitors device resource usage over time and assigns an availability score depending on parameters such as the resources available. The availability score defines an urgency threshold, which is the minim urgency that a file should have in order to be backed up at that point in time. As the available resources of a device decrease, the urgency threshold increases. Urgency scores are derived for files based on parameters such as file size, number of changed bytes since last backup, usage history, file type, creator, and the time it was last backed up. Files with urgency scores exceeding the available threshold are backed up immediately, and others are postponed until their urgency score increases because too much time has elapsed since the last back up, or when more resources become available and the availability score increases.

### BRIEF DESCRIPTION OF THE DRAWINGS

FIG. 1 is a diagram illustrating a communication network including several client devices and a backup device.

FIG. 2 is a diagram illustrating a client device and a backup device communicating through a wireless network.

FIG. 3 is a flow chart of a method of backing up files to a storage device.

FIG. 4 is a conceptual data flow diagram illustrating the data flow between different modules/means/components in an exemplary apparatus.

FIG. 5 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), compact disk ROM (CD-ROM) or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

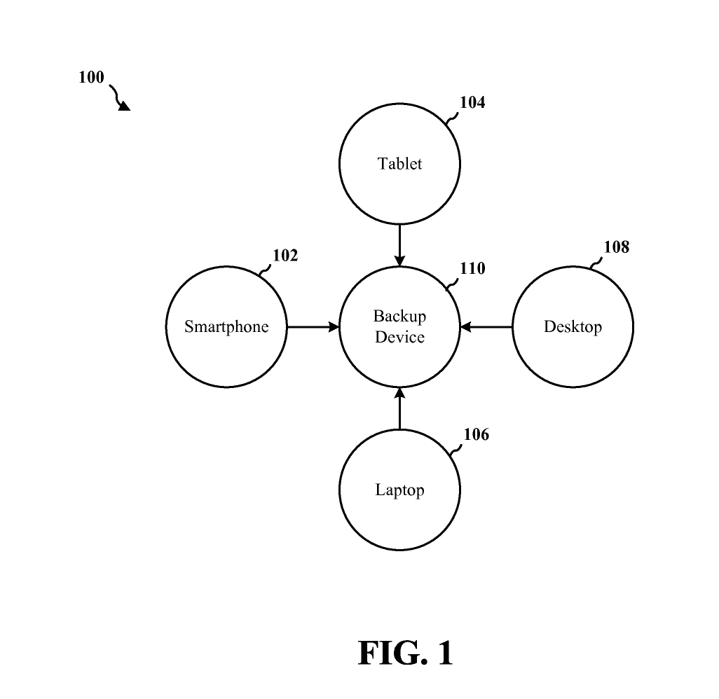

FIG. 1 is a diagram 100 illustrating a communication network including several client devices 102, 104, 106, 108 and a backup device 110. The client devices may include for example, a Smartphone 102, a tablet 104, a laptop 106, and a desktop computer 108. The communication network may be a wireless local area network (WLAN), such as a home Wi-Fi network. In accordance with the backup algorithm disclosed herein, each client device 102, 104, 106, 108 may determine to back up files to the backup device based on the availability of resources at the client device and particular parameters associated with the files. The algorithm allows for the back up of files at a time that is minimally invasive to the user. The end result is a system that backs files up in a timely manner but presents no noticeable degradation in user experience when the client device is being used for other purposes.

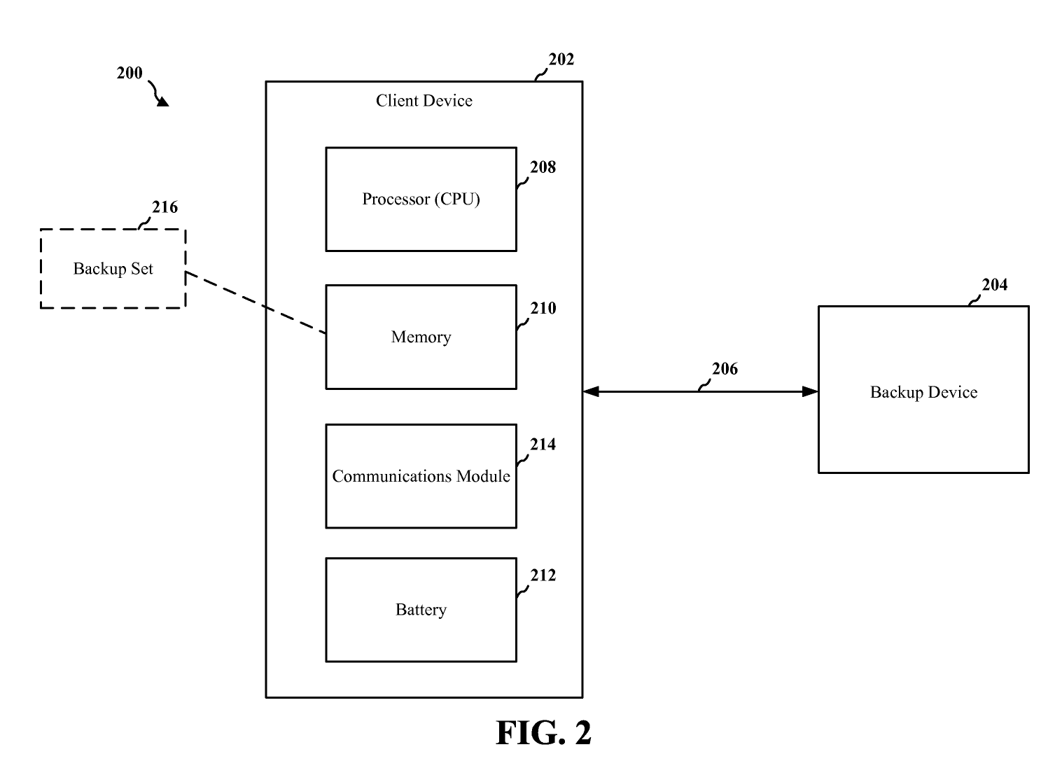

FIG. 2 is a diagram 200 illustrating a client device 202 and a backup device 204 communicating through a wireless network 206. The client device 202 includes various resources, such as a processor 208, a memory 210, a battery 212 and a communications module 214. The memory 210 stores files, including operating software for the device and other files created using the device, such as text files, data files, image files, audio files, and video files. Included in the memory 210 is a file folder that includes files that should be backed up at some point. These files in the folder are referred to as a backup set 216. The communications module 214 facilitates communication between the client device 202 and the backup device 204.

In accordance with the backup algorithm disclosed herein, multiple factors are taken into consideration when determining whether to back up a file from a client device by transmitting the file to a backup device. These factors include the availability of resources of the client device to perform the backup and the urgency with which a file should be backed up. Regarding availability, metrics related to device resources are obtained and a numeric value is derived from these metrics. The availability metrics and resulting numeric value are updated periodically at some time interval, e.g., on the order of seconds. Regarding urgency, metrics related to file parameters, e.g., size, modification time, creation time, etc, are obtained and a numeric value is derived from these metrics. The availability metrics and resulting numeric value are updated periodically at some time interval, e.g., on the order of seconds. The algorithm selects the ideal time to back up a file by monitoring both device resource availability and file urgency.

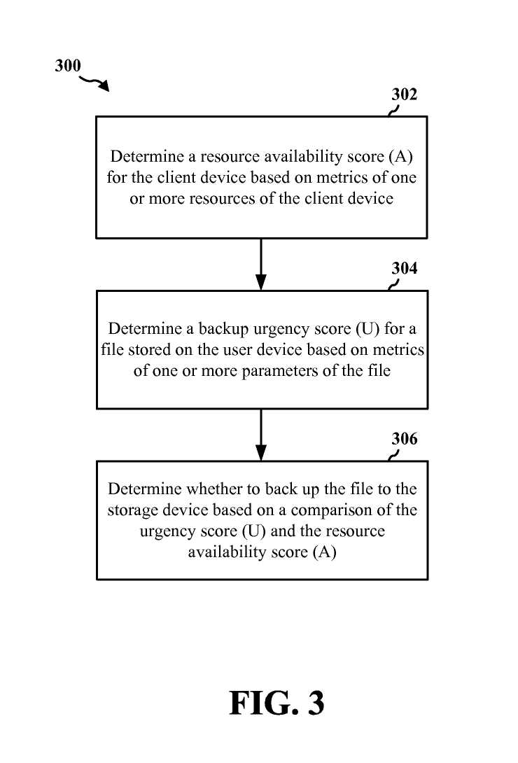

FIG. 3 is a flow chart 300 of a method of backing up files to a storage device. The method may be performed by a client device. At step 302, the client device determines a resource availability score (A) for the client device based on metrics of one or more resources of the client device. The resources may include a central processing unit (CPU) 208, memory 210, a battery 212, a communications module 214. These resources have corresponding metrics related to the operation state of the client device. The metrics, in turn, provide a measure of availability of the client device for performing backup operations.

Metrics associated with the CPU 208 may include a measure of CPU load currently being used by the client device. This metrics may be presented in terms of a percentage being used. Metrics associated with the memory 210 may include a measure of memory being used by the client device. This metrics may be presented in terms of a number of bytes.

Metrics associated with the battery 212 may include battery level. This metrics may be presented in terms of a percentage of battery charge remaining. An additional metric for the battery 212 may include charging status, which may be presented as either on, when the battery is being charged, or off when the battery is not being charged.

Metrics associated with the communications module 214 may include the network utilization and signal strength. Network utilization may be presented in terms of kilobytes per second. Signal strength provides a measure of the transmission capability of the client device. This metric may be presented in terms of one or more of a received signal strength indicator (RSSI), usable portion of received signal (E_{c}/I₀), a received signal code power (RSCP), a reference signal received power (RSRP), a reference signal received power (RSRQ), bit error rate, and pathloss.

These metrics are used to provide the availability score (A). The availability score indicates how available the client device is for backup. In one implementation, the availability score (A) is a non-negative real number with higher scores indicating more resource availability. In other words, the higher the availability score (A), the more available the device is for performing back up. For example, if a client device is being used to play a resource-intensive game that requires significant processing, the availability score (A) will be lower relative to when the client device is doing nothing.

In one configuration, to determines a resource availability score (A), the client device translates a native resource metric for each resource to a common availability metric using an availability metric function, and sums the common availability metrics.

The availability score (A) may be defined as follows:

$$A = {\sum }_{i = 0}^{n} {f}_{i} ( {M}_{i} )$$

where,
n: Number of metrics to consider.
f: Metric function, used to translate metric score to a usable availability score. This function may be as simple as multiplying by a fixed coefficient, or scaling exponentially with the metric score.
M: Metric score, real number. It may be one or more of the above described CPU load, memory usage, battery level, charging status, network utilization and signal strength metrics (e.g., percentage for CPU load and battery level, number of bytes for memory usage, etc.)

At step 304, the client device determines a backup urgency score (U) for a file stored on the user device based on metrics of one or more file parameters of the file. The file may be included in the backup set 216. The one or more file parameters may include: file size, multipurpose internet mail extensions (MIME) type, file modification, file access, file creation, file backup, and file creator.

These one or more file parameters associated with the file have corresponding metrics. The metrics, in turn, provide a measure of urgency for the file to be backed up. Metrics associated with the file size may be a measure of the size of the file. This metric may be presented in bytes. Metrics associated with MIME type may be implemented by a piecewise function mapping individual file types to metric values that can be summed in the previous equation.

Metrics associated with file modification may include a time since last modification of the file. Metrics associated with file access may include a time since last access of the file. Metrics associated with file creation may include a time since creation of the file. Metrics associated with file backup may include a time since last back up. Each of the foregoing metrics may be presented in terms of time, e.g., hours, seconds.

In one configuration, to determine a backup urgency score (U), the client device translates a native file metric for each file parameter to a common urgency metric using an urgency metric function, and sums the common urgency metrics.

The urgency score U may be defined similarly to the availability score A, as follows:

$$U = {\sum }_{i = 0}^{n} {f}_{i} ( {M}_{i} )$$

where,
n: Number of metrics to consider.
f: Metric function, used to translate metric score to a usable availability score. This function may be as simple as multiplying by a fixed coefficient, or scaling exponentially with the metric score.
M: Metric score, real number. These metrics may include—file size, multipurpose internet mail extensions (MIME) type, file modification timestamp, timestamp of last file access, file creation timestamp, timestamp of last file backup, and the file creator or modifier.

Finally, at step 306, the client device determines whether to back up the file to the storage device based on a comparison of the urgency score (U) and the resource availability score (A). In this instance, the availability score (A) may be thought of as an urgency threshold (A). In one configuration, the comparison corresponds to an inequality, such as U<A, and the file is backed up when the inequality is satisfied. This inequality essentially means that a file is backed up when the client device has sufficient resources (e.g., the availability score is high enough) to perform the back up. For all files where the inequality is satisfied, the files are backed up at that point in time. Other files are not backed up until the file is manipulated in some way such that the urgency score (U) of the file has decreased, or the device utilization has changed such that resource availability score (A) of the device has increased.

For files that were backed up and then not accessed for a certain duration, the client device may delete the file from the local file system but maintain a copy on the backup device. This approach would allow for a “rolling window” where the client device hosts the most recent content, but a continuous history is maintained on the backup device. The client application could present an interface that shows all files together, and download requested files when they are requested.

Following is an example of case of backing up a file in accordance with the method of FIG. 3. Consider a mobile device with the following specifications:
2 GHz quad-core CPU
4 GB RAM
LTE modem
2800 mAh battery

The urgency threshold A can be defined by the following function:

$$A = {\sum }_{i = 0}^{n} {f}_{i} ( {M}_{i} ) = {f}_{CPU} + {f}_{RAM} + {F}_{Modem}$$

The following metric functions are used:
(1) The CPU metric function is defined by C, the percentage CPU load on CPU core i. The metric function also depends on the battery level; that is, the metric functions need not be entirely independent.

$${f}_{CPU} ( C ) = \{ \begin{matrix}20 ( \frac{4 - {\sum }_{i = 1}^{4} {C}_{i}}{4} ) , & battery \geq 20 \% \\ 10 ( \frac{4 - {\sum }_{i = 1}^{4} {C}_{i}}{4} ) , & battery < 20 \%\end{matrix}$$

(2) The memory metric function is defined by R, the number of free bytes of RAM in the device.

$${f}_{RAM} ( R ) = 30 ( \frac{4 \cdot {10}^{9} bytes - R}{4 \cdot {10}^{9} bytes} )$$

(3) The modem metric function is defined by S, the modem's signal strength (RSRP, measured in dBm).

$${f}_{Modem} ( S ) = 40 ( \frac{- 10 dBm}{S} )$$

Now, consider a file with the following parameters:
4 MB .doc file
Last backed up 28 hours ago
500 KB changed since last backup

The urgency score for this file can be defined by the following function:

$$U = {\sum }_{i = 0}^{n} {f}_{i} ( {M}_{i} ) = {f}_{Type} + {f}_{Age} + {f}_{Delta}$$

The following metric functions are used:
(1) The type metric function is a piecewise function that maps specific file types (T, either extensions or MIME types) to urgency scores.

$${f}_{Type} ( T ) = \{ \begin{matrix}20 & T = doc , docx \\ 15 & T = txt , rtf \\ 10 & otherwise\end{matrix}$$

(2) The age metric function increases a file's urgency score as the number of hours (H) since the last backup increases.

$${f}_{Age} ( H ) = \{ \begin{matrix}20 ( \frac{H}{48} ) , & H \leq 48 \\ 20 , & H > 48\end{matrix}$$

(3) The delta metric function increases a file's urgency score as the number of bytes (B) that have changed since the last backup increases.

$${f}_{Delta} ( B ) = \{ \begin{matrix}60 ( \frac{B}{{10}^{7}} ) , & H \leq {10}^{7} \\ 60 , & H > {10}^{7}\end{matrix}$$

Now, consider the following scenario where the previous file is considered for backup under the following conditions:
80% CPU load on all cores
700 MB RAM free
−50 dBm signal strength on LTE modem
75% battery level

The urgency threshold for the system at the given point in time is given by

A=f_{CPU}+f_{RAM}+f_{Modem}:

$${f}_{CPU} ( 0.8 , 0.8 , 0.8 , 0.8 ) = 20 ( \frac{4 - {0.8}^{4}}{4} ) = 17.95$$

$${f}_{RAM} ( 7 \cdot {10}^{7} ) = 30 ( \frac{4 - {10}^{9} - 7 \cdot {10}^{7} bytes}{4 \cdot {10}^{9} bytes} ) = 29.48$$

$${f}_{Modem} ( - 50 dBm ) = 40 ( \frac{- 10 dBm}{- 50 dBm} ) = 8$$

$$A = {f}_{CPU} + {f}_{RAM} + {f}_{Modem} = 17.95 + 29.48 + 8 = 55.43$$

The urgency score for the file is given by U=f_{Type}+f_{Age}+f_{Delta}:

$${f}_{Type} ( doc ) = 20$$

$${f}_{Age} ( 28 ) = 20 ( \frac{28}{48} ) = 11.67$$

$${f}_{Delta} ( 4 \cdot {10}^{6} ) = 60 ( \frac{4 \cdot {10}^{6}}{{10}^{7}} ) = 24$$

$$U = {f}_{Type} + {f}_{Age} + {f}_{Delta} = 20 + 11.67 + 24 = 55.67$$

So, the file will be backed up since the urgency score (55.67) exceeds the urgency threshold (55.43).

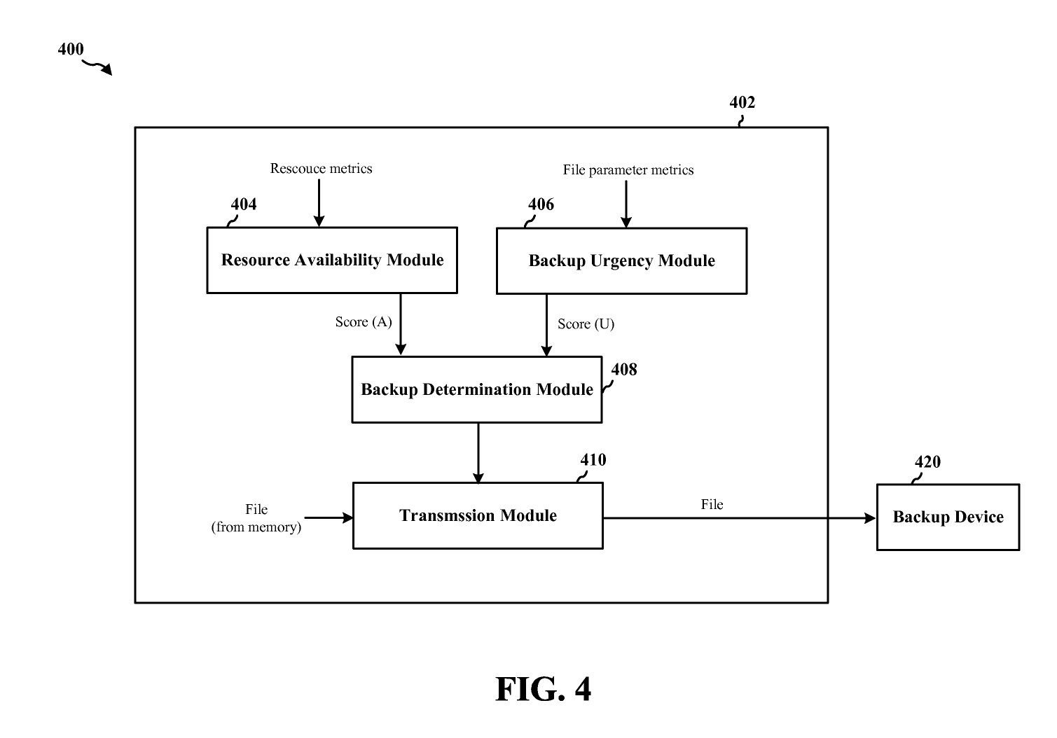

FIG. 4 is a conceptual data flow diagram 400 illustrating the data flow between different modules/means/components in an exemplary apparatus 402. The apparatus may be a client device. The apparatus 402 includes a resource availability module 404, a backup urgency module 406, a backup determination module 408, and a transmission module 410.

The resource availability module 404 determine a resource availability score (A) for the client device 402 based on metrics of one or more resources of the client device. The backup urgency module 406 determine a backup urgency score (U) for a file stored on the user device based on metrics of one or more file parameters of the file. The backup determination module 408 determine whether to back up the file to the storage device based on a comparison of the urgency score (U) and the resource availability score (A). The transmission module 410 transmits files that are determined to be backed up to the backup device 420.

The apparatus 402 may include additional modules that perform each of the steps of the algorithm in the aforementioned flow chart of FIG. 3. As such, each step in the aforementioned flow charts of FIG. 3 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof

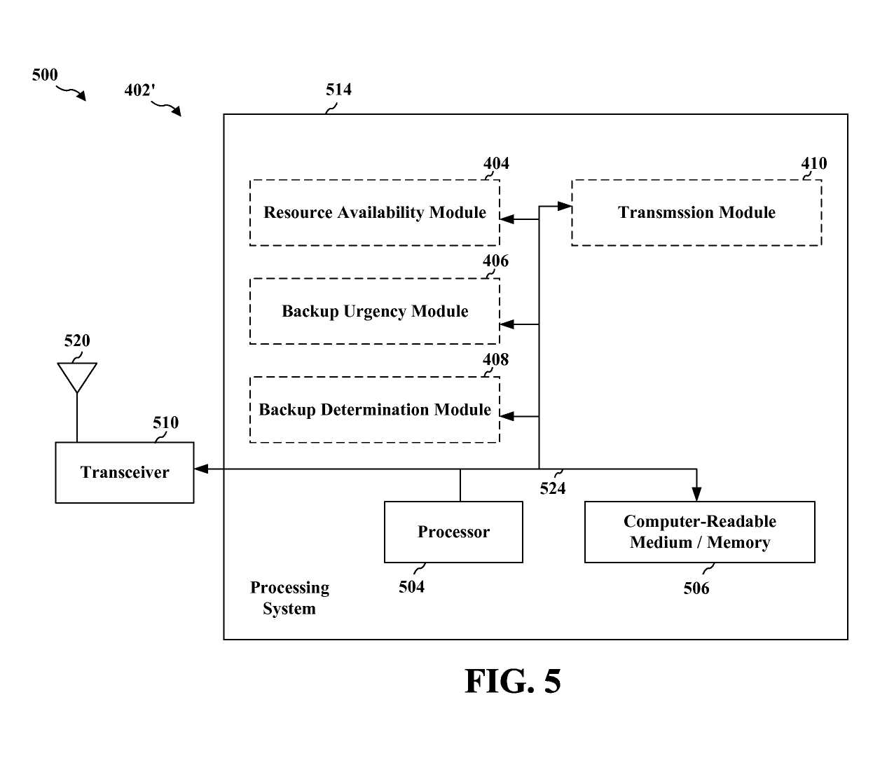

FIG. 5 is a diagram 500 illustrating an example of a hardware implementation for an apparatus 402′ employing a processing system 514. The processing system 514 may be implemented with a bus architecture, represented generally by the bus 524. The bus 524 may include any number of interconnecting buses and bridges depending on the specific application of the processing system 514 and the overall design constraints. The bus 524 links together various circuits including one or more processors and/or hardware modules, represented by the processor 504, the modules 404, 406, 408, 410 and the computer-readable medium/memory 506. The bus 524 may also link various other circuits such as timing sources, peripherals, voltage regulators, and power management circuits, which are well known in the art, and therefore, will not be described any further.

The processing system 514 may be coupled to a transceiver 510. The transceiver 510 is coupled to one or more antennas 520. The transceiver 510 provides a means for communicating with various other apparatus over a transmission medium. The transceiver 510 receives a signal from the one or more antennas 520, extracts information from the received signal, and provides the extracted information to the processing system 514. In addition, the transceiver 510 receives information from the processing system 514, specifically the transmission module 410, and based on the received information, generates a signal to be applied to the one or more antennas 520. The processing system 514 includes a processor 504 coupled to a computer-readable medium/memory 506. The processor 504 is responsible for general processing, including the execution of software stored on the computer-readable medium/memory 506. The software, when executed by the processor 504, causes the processing system 514 to perform the various functions described supra for any particular apparatus. The computer-readable medium/memory 506 may also be used for storing data that is manipulated by the processor 504 when executing software. The processing system further includes at least one of the modules 404, 406, 408 and 410. The modules may be software modules running in the processor 504, resident/stored in the computer readable medium/memory 506, one or more hardware modules coupled to the processor 504, or some combination thereof

It is understood that the specific order or hierarchy of steps in the processes/flow charts disclosed is an illustration of exemplary approaches. Based upon design preferences, it is understood that the specific order or hierarchy of steps in the processes/flow charts may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.” Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of backing up files to a storage device, comprising:
determining a resource availability score (A) for a client device based on metrics of one or more resources of the client device;
determining a backup urgency score (U) for a file stored on the user device based on metrics of one or more file parameters of the file;
determining whether to back up the file to the storage device based on a comparison of the urgency score (U) and the resource availability score (A).

2. The method of claim 1, wherein the comparison comprises an inequality and the file is backed up when the inequality is satisfied.

3. The method of claim 1, wherein the inequality is U<A.

4. The method of claim 1, wherein determining a resource availability score (A) comprises:
translating a native resource metric for each resource to a common availability metric using an availability metric function; and
summing the common availability metrics.

5. The method of claim 4, wherein the metrics of one or more resources comprise at least one of a metric of a central processing unit, memory usage, battery level, charging status, network utilization and signal strength.

6. The method of claim 1, wherein determining a backup urgency score (U) comprises:
translating a native file metric for each file parameter to a common urgency metric using an urgency metric function; and
summing the common urgency metrics.

7. The method of claim 6, wherein the metrics of one or more file parameters comprise at least one of a metric of a file size, multipurpose internet mail extensions (MIME) type, time since last modification, time since last access, time since creation, time since last backup, and file creator.

8. An apparatus for backing up files to a storage device, comprising:
means for determining a resource availability score (A) for a client device based on metrics of one or more resources of the client device;
means for determining a backup urgency score (U) for a file stored on the user device based on metrics of one or more file parameters of the file;
means for determining whether to back up the file to the storage device based on a comparison of the urgency score (U) and the resource availability score (A).

9. The apparatus of claim 8, wherein the comparison comprises an inequality and the file is backed up when the inequality is satisfied.

10. The apparatus of claim 8, wherein the inequality is U<A.

11. The apparatus of claim 8, wherein the means for determining a resource availability score (A) is configured to:
translate a native resource metric for each resource to a common availability metric using an availability metric function; and
sum the common availability metrics.

12. The apparatus of claim 11, wherein the metrics of one or more resources comprise at least one of a metric of a central processing unit, memory usage, battery level, charging status, network utilization and signal strength.

13. The apparatus of claim 8, wherein the means for determining a backup urgency score (U) is configured to:
translate a native file metric for each file parameter to a common urgency metric using an urgency metric function; and
sum the common urgency metrics.

14. The apparatus of claim 13, wherein the metrics of one or more file parameters comprise at least one of a metric of a file size, multipurpose internet mail extensions (MIME) type, time since last modification, time since last access, time since creation, time since last backup, and file creator.

15. An apparatus for backing up files to a storage device, comprising:
a memory; and
at least one processor coupled to the memory and configured to:
determine a resource availability score (A) for a client device based on metrics of one or more resources of the client device;
determine a backup urgency score (U) for a file stored on the user device based on metrics of one or more file parameters of the file;
determine whether to back up the file to the storage device based on a comparison of the urgency score (U) and the resource availability score (A).

16. The apparatus of claim 15, wherein the comparison comprises an inequality and the file is backed up when the inequality is satisfied.

17. The apparatus of claim 15, wherein the inequality is U<A.

18. The apparatus of claim 15, wherein to determine a resource availability score (A), the processor is further configured to:
translate a native resource metric for each resource to a common availability metric using an availability metric function; and
sum the common availability metrics.

19. The apparatus of claim 18, wherein the metrics of one or more resources comprise at least one of a metric of a central processing unit, memory usage, battery level, charging status, network utilization and signal strength.

20. The apparatus of claim 15, wherein to determine a backup urgency score (U), the processor is further configured to:
translate a native file metric for each file parameter to a common urgency metric using an urgency metric function; and
sum the common urgency metrics.

21. The apparatus of claim 20, wherein the metrics of one or more file parameters comprise at least one of a metric of a file size, multipurpose internet mail extensions (MIME) type, time since last modification, time since last access, time since creation, time since last backup, and file creator.

22. A computer program product for backing up files to a storage device, comprising:
a computer-readable medium comprising code for:
determining a resource availability score (A) for a client device based on metrics of one or more resources of the client device;
determining a backup urgency score (U) for a file stored on the user device based on metrics of one or more file parameters of the file;
determining whether to back up the file to the storage device based on a comparison of the urgency score (U) and the resource availability score (A).

23. The product of claim 22, wherein the comparison comprises an inequality and the file is backed up when the inequality is satisfied.

24. The product of claim 22, wherein the inequality is U<A.

25. The product of claim 22, wherein code for determining a resource availability score (A) comprises code for:
translating a native resource metric for each resource to a common availability metric using an availability metric function; and
summing the common availability metrics.

26. The product of claim 25, wherein the metrics of one or more resources comprise at least one of a metric of a central processing unit, memory usage, battery level, charging status, network utilization and signal strength.

27. The product of claim 22, wherein code for determining a backup urgency score (U) comprises code for:
translating a native file metric for each file parameter to a common urgency metric using an urgency metric function; and
summing the common urgency metrics.

28. The product of claim 27, wherein the metrics of one or more file parameters comprise at least one of a metric of a file size, multipurpose internet mail extensions (MIME) type, time since last modification, time since last access, time since creation, time since last backup, and file creator.
